(19) United States
(12) Patent Application Publication
(10) Pub. No.: US 2007/0026732 A1
(43) Pub. Date: Feb. 1, 2007

(54) GROUNDING CONNECTORS

(75) Inventor: Zhejia Zhang, DongGuan City (CN)

Correspondence Address: MATTHIAS SCHOLL, 14781 MEMORIAL DRIVE, SUITE 1319, HOUSTON, TX, 77079, US

(73) Assignee: DONGGUAN COMAX ELECTRON LTD., DongGuan City (CN)

(21) Appl. No.: 11/460,923

(22) Filed: Jul. 28, 2006

(30) Foreign Application Priority Data
Jul. 29, 2005 (CN) 200510036367.X

(51) Int. Cl. H01R 9/05

(52) U.S. Cl. 439/581

(57) ABSTRACT

Taught herein are electric connectors, e.g., for connecting electrical wire to a receiving interface, comprising an insulator body, and one or more transmission and grounding terminals having a particular spatial arrangement so as to maximize the amount of digital data transferred and to maximize the signal to noise ratio of the transferred signal.

### CROSS-REFERENCE TO RELATED APPLICATIONS

This application claims priority to the Chinese Application No. CN 200510036367.X, filed Jul. 29, 2005, the contents of which are incorporated herein by reference.

### BACKGROUND OF THE INVENTION

1. Field of the Invention

This invention relates to electric connectors, and more particularly to electric connectors that are provided with grounding shelters.

2. Description of the Prior Art

With the advent of digital signal transfer (DVD and other multimedia) connectors and interfaces for transmitting digital content and providing better signal-to-noise ratios have been developed in recent years (e.g., DV1). Among these, High-Definition Multimedia Interface (HDMI) provides high speed data transfer without relying on larger electric connectors and/or a large number of conducting wires. However, these connectors have the shortcomings of excessive signal interference. Accordingly, there is an urgent need for developing electric connectors which can not only provide high speed digital data transfer, but also transfer signals at high signal-to-noise ratios.

### SUMMARY OF THE INVENTION

This invention is directed to an electric connector, e.g., for connecting electrical wire to a receiving interface, comprising an insulator body, having a first end and a second end; a plurality of fist transmission terminals; a plurality of second transmission terminals; a plurality of first grounding terminals; and a plurality of second grounding terminals; wherein the first transmission terminals form a first row of terminals; the second transmission terminals form a second row of terminals; and the first grounding terminals and said second grounding terminals form a third row of terminals.

In certain embodiments of the invention the first transmission terminals and the first grounding terminals form a first row of terminals; and the second transmission terminals and the second grounding terminals form a second row of terminals.

In certain embodiments of the invention the first transmission terminals on the first plane and the second transmission terminals on the second plane are arranged with spatial irregularity.

In certain embodiments of the invention the first transmission terminals on the first plane and the second transmission terminals on the second plane and the grounding terminals on the third plane are arranged with spatial irregularity.

In certain embodiments of the invention the plurality of fist transmission terminals, the plurality of second transmission terminals, the plurality of first grounding terminals, and the plurality of second grounding terminals are mounted between the first end and the second end.

In certain embodiments of the invention the first grounding terminals and the second grounding terminals comprise one or more extended ends.

In certain embodiments of the invention one or more of the extended ends project out of the plane defined by the midsection of the first and the second grounding terminals.

In other aspects of the present invention provided is a receiving interface for an electric connector comprising plurality of guidance shafts for receiving a plurality of the transmission terminals and the grounding terminals.

In certain embodiments of the invention the receiving interface comprises further a positioning plate having a screw hole for mounting the receiving interface to a computer or a circuit board.

In other aspects of the present invention provided is an electric connector comprising one or more fist transmission terminals; one or more second transmission terminals; one or more first grounding terminals; and one or more second grounding terminals; wherein the shape of the first transmission terminals and the first grounding terminals taken together approximates the shape of the letter Y with the first grounding terminals extending spatially farther with respect to the center point of the letter Y than the first transmission terminals; and the shape of the second transmission terminals and the second grounding terminals taken together approximates the shape of the letter Y with the second grounding terminals extending spatially farther with respect to the center point of the letter Y than the second transmission terminals.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 is an exploded view showing an insulator body 1 and a receiving interface 7;

FIG. 2 is a perspective view of a connector having an insulator body 1, and an exploded view of a receiving interface 7;

FIG. 3A is an amplified perspective view showing transmission terminals and grounding terminals;

FIG. 3B is a sectional view showing transmission terminals and grounding terminals;

FIG. 3C is a front plane view (viewing from the second end 12) showing an insulator body 1;

FIG. 4 is an exploded perspective view showing insulator body 1, including transmission terminals and grounding terminals;

FIG. 5 is a cross-sectional view showing an insulator body 1 inserted into a receiving interface 7.

### DETAILED DESCRIPTION OF THE INVENTION

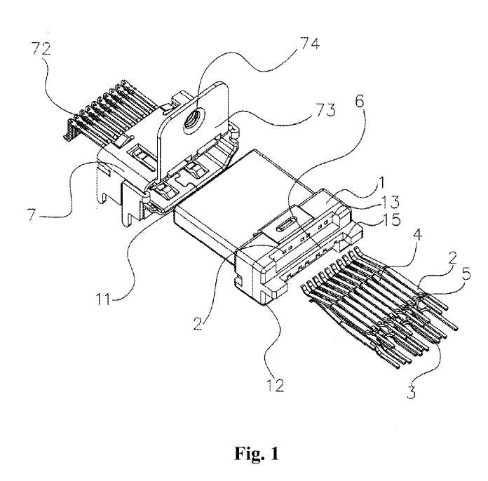

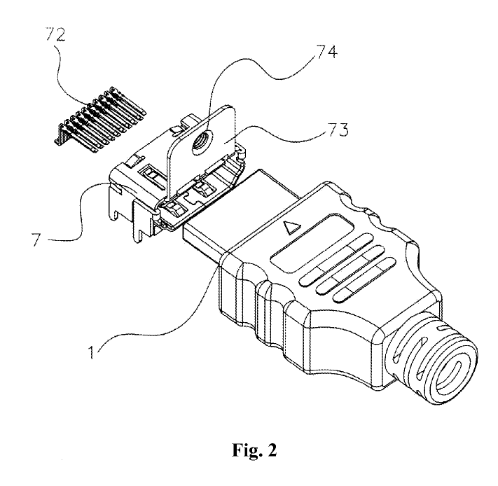

Referring to FIG. 1, a connector according to this invention comprises an insulator body 1 having a first end 11 and a second end 12; a plurality of fist transmission terminals 2; a plurality of second transmission terminals 3; a plurality of first grounding terminals 4; and a plurality of second grounding terminals 5.

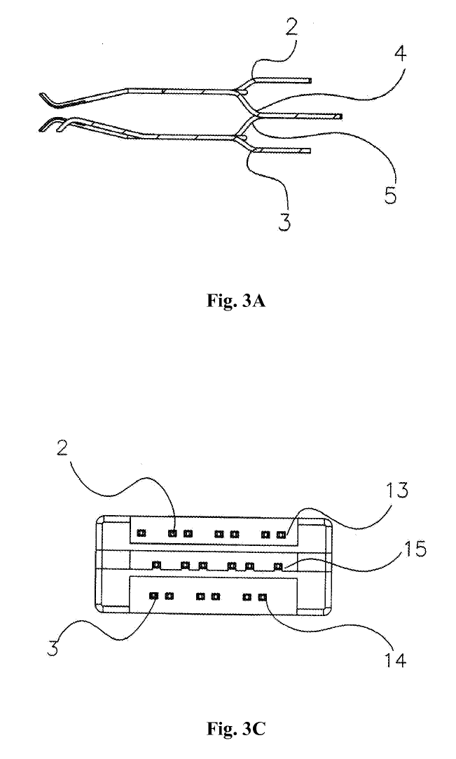

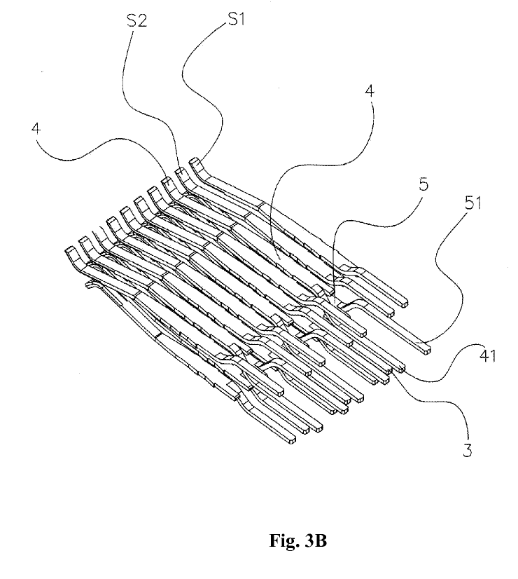

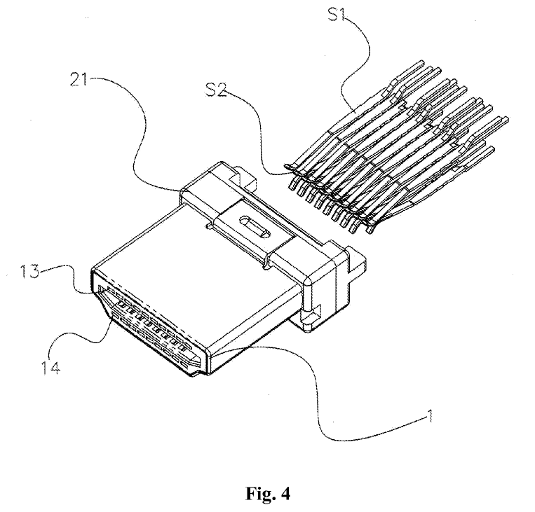

A plurality of the fist and the second transmission terminals 2, 3 and of the first and the second grounding terminals 4, 5 are mounted between the first end 11 and the second end 12. The first and the second grounding terminals 4, 5 are disposed between the first transmission terminals 2 and the second transmission terminals 3, thereby providing separate electrical connections. With reference to FIGS. 3 and 4, each transmission terminal 2, 3 is provided with a pair of transmission terminals S1 and S2.

The first end 11 of the insulator body 1 is comprised of two rows of terminals, terminal row 13 and terminal row 14, respectively. The fist transmission terminals 2 and the first grounding terminals 4 are disposed on the first row 13; the second transmission terminals 3 and the second grounding terminals 5 are disposed on the second row 14.

With reference to FIGS. 3B and 3C, each grounding terminal 4, 5 extends at the second end 12 of the insulator body 1 and terminates with an extended end 41, 51.

The extended ends 41, 51 project (i.e., curvedly extend) out of the plane defined by the midsection of the terminals 4, 5 within the insulator body 1 so as to form a third row of terminals 15. The third row of terminals 15 is disposed between the first row of terminals 13 and the second row of terminals 14.

The first transmission terminals 2 on the first plane 13 and the second transmission terminals 3 on the second plane 14 are arranged with spatial irregularity, for example as shown in FIG. 3C. This has a positive impact on the grounding of the connection and desirable signal transmission.

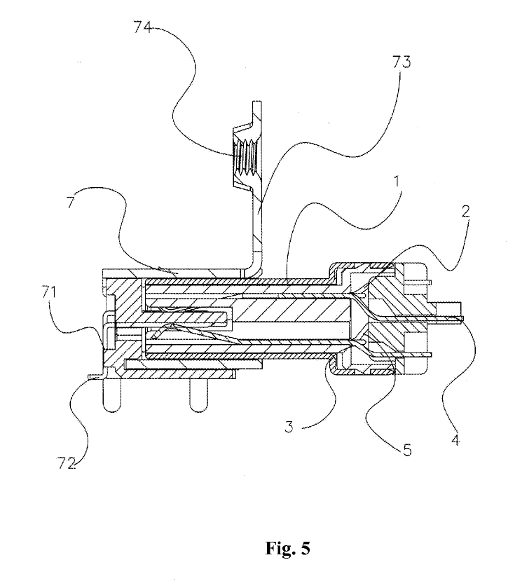

Referring to FIG. 5, the insulator body 1 of the electric connector is inserted into a receiving interface 7. The interface 7 has a plurality of guidance shafts into which a plurality of the terminals insert. At the edge of the receiving interface 7, disposed is a positioning plate 73, which is provided with a screw hole 74 for mounting the receiving interface 7 to a computer or a circuit board.

This design of the electric connector provides a competitive and reliable connection for digital data transfer.

It is to be understood that the embodiments described herein are merely illustrative of the principles of the invention and that a wide variety of modifications and variation thereto may be effected by persons skilled in the art without departing from the spirit and scope of the invention as set forth in the following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. An electric connector comprising
an insulator body, having a first end and a second end;
a plurality of fist transmission terminals;
a plurality of second transmission terminals;
a plurality of first grounding terminals; and
a plurality of second grounding terminals; wherein
said first transmission terminals form a first row of terminals;
said second transmission terminals form a second row of terminals; and
said first grounding terminals and said second grounding terminals form a third row of terminals.

2. The electric connector of claim 1 wherein
said first transmission terminals and said first grounding terminals form a first row of terminals; and
said second transmission terminals and said second grounding terminals form a second row of terminals.

3. The electric connector of claim 1 wherein said first transmission terminals on said first plane and said second transmission terminals on said second plane are arranged with spatial irregularity.

4. The electric connector of claim 1 wherein said first transmission terminals on said first plane and said second transmission terminals on said second plane and said grounding terminals on said third plane are arranged with spatial irregularity.

5. The electric connector of claim 1 wherein said plurality of fist transmission terminals, said plurality of second transmission terminals, said plurality of first grounding terminals, and said plurality of second grounding terminals are mounted between said first end and said second end.

6. The electric connector of claim 1 wherein said first grounding terminals and said second grounding terminals comprise one or more extended ends.

7. The electric connector of claim 6 wherein one or more of said extended ends project out of the plane defined by the midsection of said first and said second grounding terminals.

8. A receiving interface for an electric connector of claim 1 comprising plurality of guidance shafts for receiving a plurality of said transmission terminals and said grounding terminals.

9. The receiving interface of claim 8 comprising further a positioning plate having a screw hole for mounting the receiving interface to a computer or a circuit board.

10. An electric connector comprising
one or more fist transmission terminals;
one or more second transmission terminals;
one or more first grounding terminals; and
one or more second grounding terminals; wherein
the shape of said first transmission terminals and said first grounding terminals taken together approximates the letter Y with said first grounding terminals extending spatially farther with respect to the center point of the letter Y than said first transmission terminals; and
the shape of said second transmission terminals and said second grounding terminals taken together approximates the letter Y with said second grounding terminals extending spatially farther with respect to the center point of the letter Y than said second transmission terminals.
